(19) United States
(12) Patent Application Publication
(10) Pub. No.: US 2018/0232731 A1
(43) Pub. Date: Aug. 16, 2018

(54) SUPPLY CHAIN RECORDING METHOD WITH TRACEABLE FUNCTION BY IMPLEMENTING BLOCKCHAIN TECHNIQUE

(71) Applicant: DIGITAL TREASURY CORPORATION, TAIPEI CITY (TW)

(72) Inventor: YEH-CHUN LIU, TAIPEI CITY (TW)

(21) Appl. No.: 15/432,201

(22) Filed: Feb. 14, 2017

(51) Int. Cl. G06Q 20/38

(52) U.S. Cl. CPC G06Q 20/3823; G06Q 2220/00; G06Q 20/3827; G06Q 20/3829

(57) ABSTRACT

A supply chain recording method with traceable function by implementing blockchain technique includes steps of: releasing a plurality of first digital assets respectively from a plurality of issuers to one of a plurality of receivers as transactions; assigning a plurality of public keys respectively for the transactions; writing a plurality of first digital signatures for the transactions respectively with a private key of one of the receivers in a plurality of blocks when the first digital assets are released from one of the issuers to one of the receivers; combining the first digital assets received in one of the receivers to be one of a plurality of second digital assets; generating data relationships among the second digital asset and the first digital assets; and respectively saving and encrypting the blocks with the public keys in a blockchain by a hash algorithm.

### BACKGROUND OF THE INVENTION

### 1. Field of the Invention

The present invention relates to a supply chain recording method, and more particularly to a supply chain recording method with traceable function by implementing blockchain technique to provide traceability for the supply chain and promote transparency in the supply chain by implementing Application Programming Interface (API), bar codes or QR codes.

### 2. Description of Related Art

Bitcoin is a crytocurrency and a payment system. The system for the bitcoin is peer-to-peer and transactions take place between users directly, without an intermediary. The transaction are verified by network nodes and recorded in a blockchain.

The transaction in the blockchain is a transfer of bitcoin value that is broadcast to the network and collected into blocks. A transaction typically references previous transaction outputs as new transaction inputs and dedicates all input bitcoin value to new outputs. The transactions are not encrypted, so it is possible to browse and view every transaction ever collected into a block.

Standard transaction outputs nominate addresses, and the redemption of any future inputs requires a relevant signature. All the transactions are visible and viewable in the blockchain.

Each block contains a timestamp. The timestamp proves that the data must have existed at the time, obviously, in order to get into the hash. Each timestamp includes the previous timestamp in its hash, forming a chain.

Moreover, bitcoin uses Proof of Work to ensure blockchain security and consensus. The Proof of Work is a piece of data which is difficult to produce but easy to verify and which satisfies certain requirements. Producing a Proof of Work can be a random process with low probability so that a lot of trials and errors are required on average before a valid Proof of Work is generated.

Accordingly, since the blockchains have been very useful in transactions, there is a need to design a supply chain recording method by implementing the blockchain to secure the product transactions, and any one with authorization may track the detail information of the product manufacturing history.

### SUMMARY OF THE INVENTION

An objective of the present invention is to provide a supply chain recording method with traceable function by implementing a blockchain technique. The supply chain is secured and traceable for any buyers or sellers who are involved.

In order to achieve the aforementioned purpose in the present invention, the present invention provides a supply chain recording method with traceable function by implementing blockchain technique and includes steps of: releasing a plurality of first digital assets respectively from a plurality of issuers to one of a plurality of receivers as a plurality of transactions; assigning a plurality of public keys respectively for the transactions; writing a plurality of first digital signatures for the transactions respectively with a private key of the one of the receivers in a plurality of blocks when the first digital assets are released from one of the issuers to the one of the receivers; combining the first digital assets received in the one of the receivers to be one of a plurality of second digital assets; generating data relationships among the one of the second digital assets and the first digital assets; and respectively saving and encrypting the blocks with the public keys in a blockchain by a hash algorithm.

The advantage in the present invention is that the issuers or the receivers are able to check or track the transactions for the products or goods in the supply chain. By implementing the blockchain technique in the present invention, the transactions within the supply chain are secured and only the issuers or the receivers who get involved in the transactions are capable of tracking or checking all of the information within the transactions.

Different than the bitcoin to transfer only one digital currency, the present invention develops transmission content to be some digital assets (such as asset names, assets description, asset classifications and so on). For example, the private key signature is used to define digital asset and release quantity. In addition, the private key signature is used to transfer the ownership for the asset to the public key of the receiver (also called asset receiving address). The digital asset in the present invention is calculated and recorded by the hash algorithm, so the digital asset is not reversible. The digital asset generates a relationship for all of the transaction history information. Therefore, the digital asset can be verified by the blockchain, the ownership and the timestamp. All of the transactions are recorded in the distributed ledger and the hash value is stored in the blockchain (the public ledger).

### BRIEF DESCRIPTION OF THE DRAWINGS

FIG. 1 is a block diagram illustrating a supply chain with traceable function by implementing blockchain technique;

FIG. 2A and FIG. 2B are another two block diagrams illustrating the supply chain with traceable function by implementing the blockchain technique; and

FIG. 3 is a flow chart illustrating the supply chain recording method with traceable function by implementing the blockchain technique.

### DETAILED DESCRIPTION OF THE PREFERRED EMBODIMENT

These and other aspects of the embodiments herein will be better appreciated and understood when considered in conjunction with the following description and the accompanying drawings.

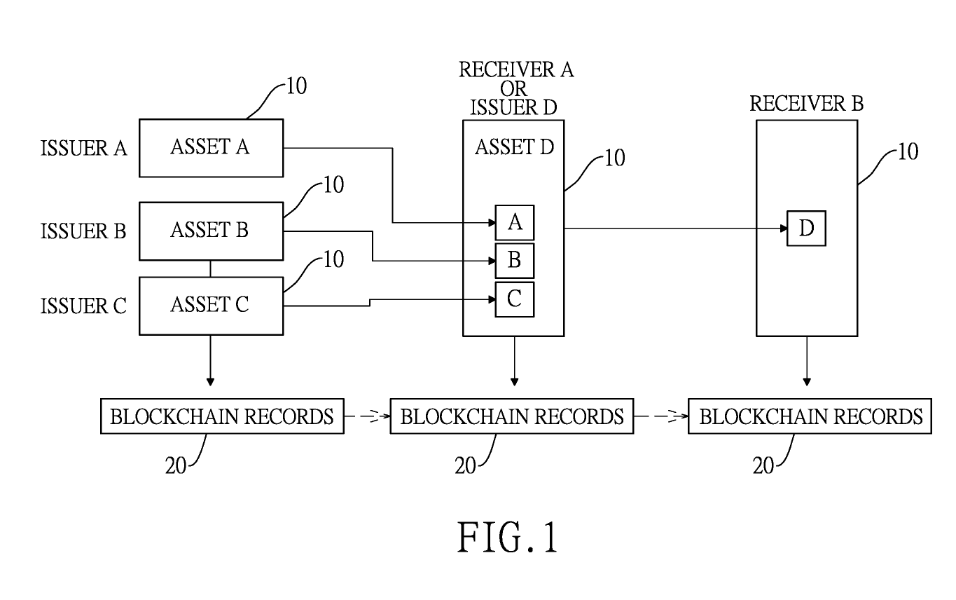

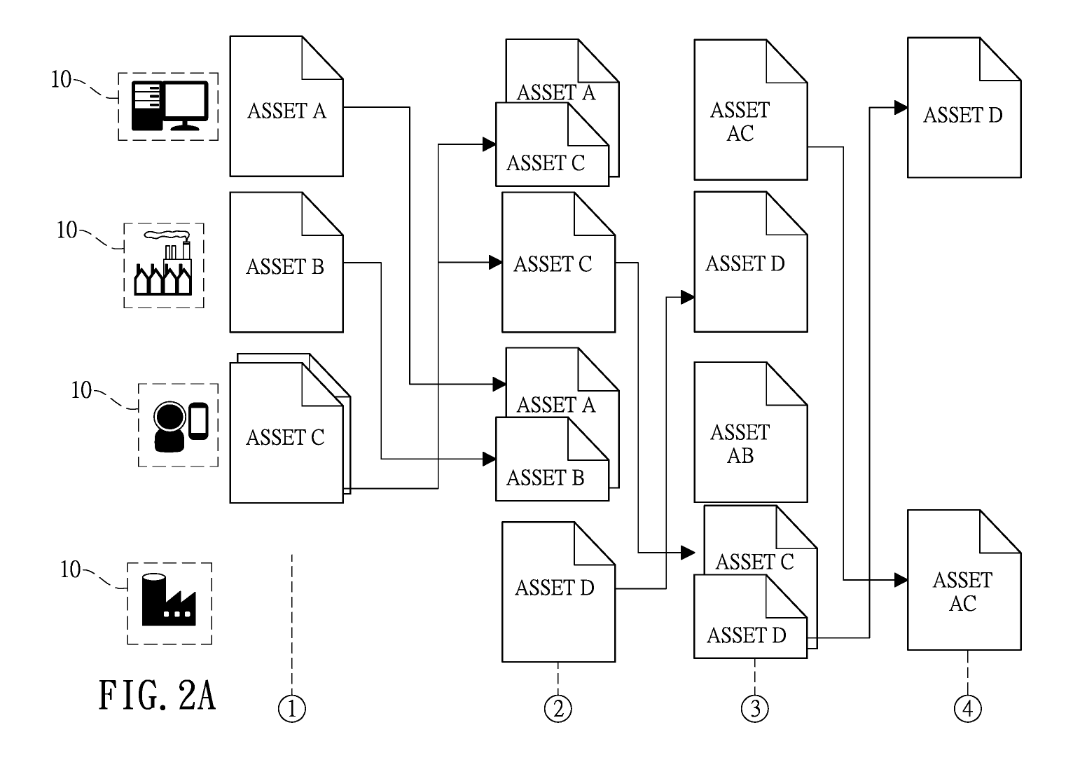

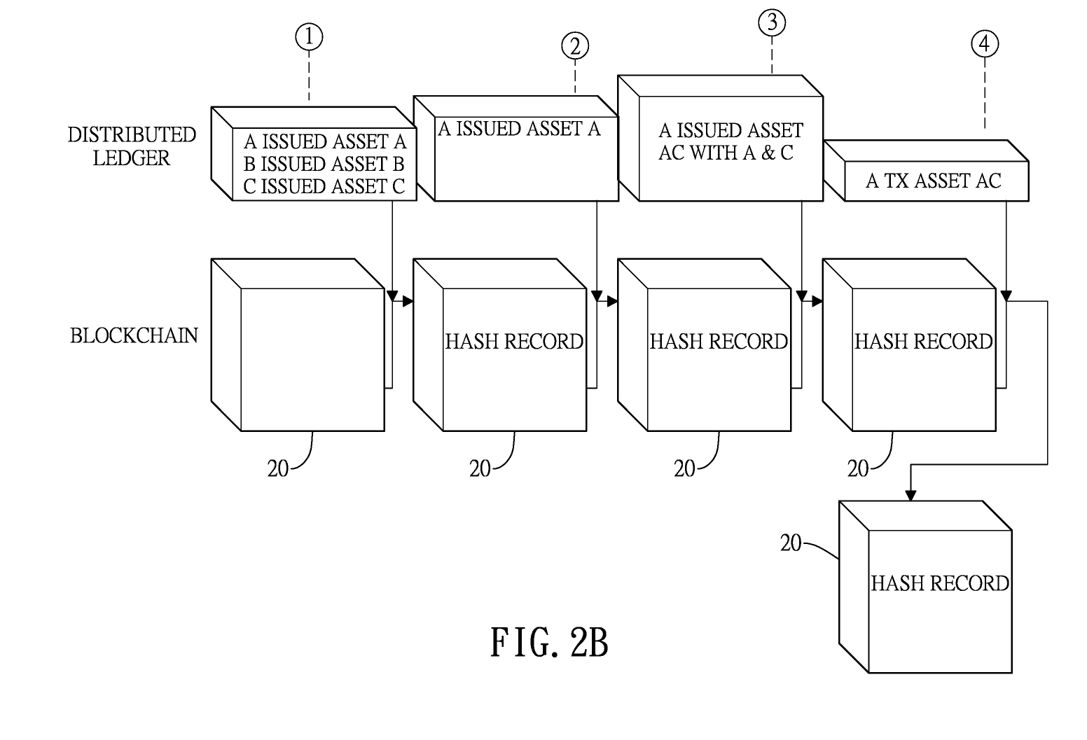

With reference to FIG. 1, FIG. 2A and FIG. 2B, a plurality of electronic devices 10 are used as a plurality of issuers (such as an issuer A, an issuer B, an issuer C, an issuer D and so on) and receivers (such as a receiver A, receiver B and so on) to transfer and receive a plurality of first digital assets (such as asset A, asset B and asset C) and second digital assets (such as asset D).

The electronic devices 10 are desktops, laptops, tablets, smart phones, etc, but it is not limited herein. The electronic devices 10 may be used by a small company, a factory, a person or a raw material supplier and so on to release a plurality of digital assets (the first digital assets or the second digital assets). The first digital assets and the second digital assets are numbers or codes representing any goods, assets or products owned by sellers or buyers. The first digital assets and the second digital assets are used to represent the digital assets released from the issuers or the receivers, but any other digital assets may be added and it is not limited in the present invention.

The electronic devices 10 are not only used as the issuers and receivers to transfer and receive the digital assets, but the electronic devices 10 will also automatically record and encrypt every transferring and receiving activities as transactions therein and saves all of the transactions occurring within a supply chain in a distributed ledger at every period of time. Thereafter, the distributed ledger is encrypted by a hash algorithm and saved in a blockchain 20. In addition, the electronic devices 10 will be assigned with a plurality of private keys respectively. A user who owns one of the private keys is capable of accessing one of the electronic devices 10 to check or track all of the transactions within the electronic device 10. The transactions will be assigned with a plurality of public keys respectively. The public keys are derived in accordance with the private key.

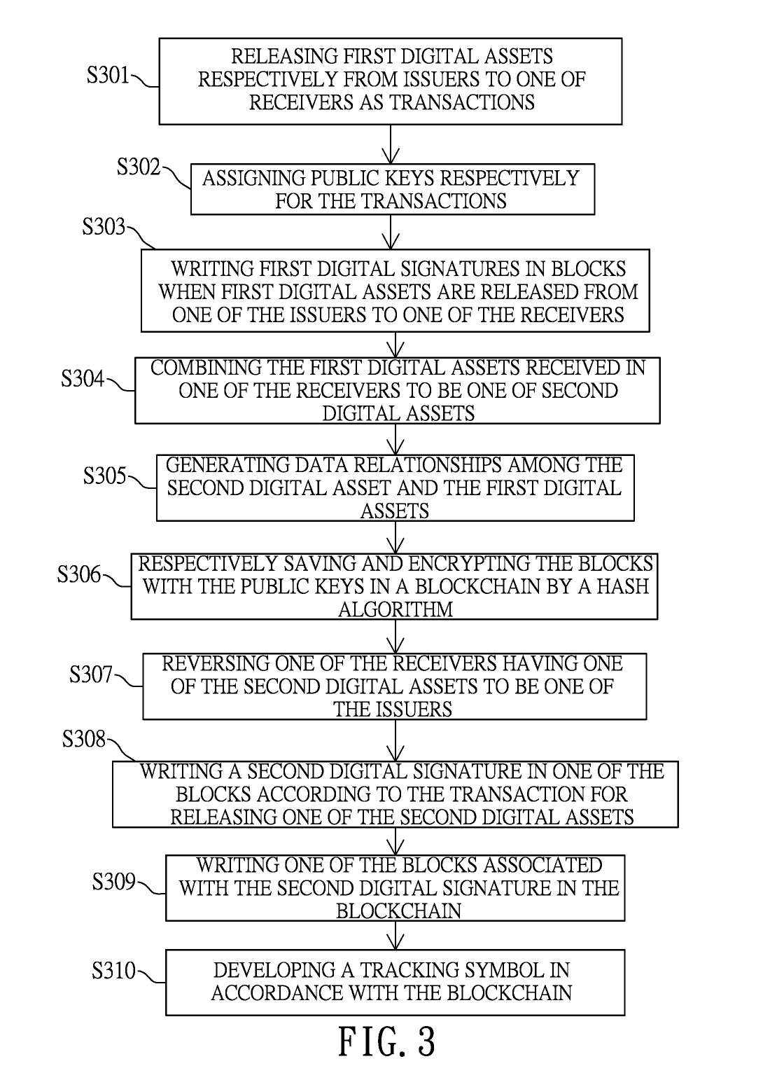

With reference to FIG. 1 FIG. 2 and FIG. 3 as reference, in step S301, a plurality of first digital assets are respectively released from a plurality of issuers to one of a plurality of receivers as a plurality of transactions. When the sellers sell any goods to a buyer, the sellers will be the issuers to use the electronic devices to transfer the first digital assets representing the goods to one buyer as the receiver. The act for each of the issuers to transfer one of the first digital assets to the receiver is called the transaction.

Specifically, each of the goods from each of the sellers will be assigned with one of the first digital assets. The codes or numbers representing the first digital assets will be encrypted by the hash algorithm. When the buyer acquires one of the first digital assets from one of the sellers, the buyer will firstly verify whether the seller has a certain amount of the first digital asset. If the seller has the certain amount of the first digital asset, the first digital asset will be released from the seller to the buyer. Furthermore, the goods described in the present invention may be real raw materials or virtual assets, and it is not limited herein.

In step S302, the transactions for the first digital assets released from the issuers to one of the receivers will be assigned with a plurality of public keys respectively. The public keys are generated and derived from the private key of the electronic device of the receiver. The encryption and decryption of the public key and the private key implement a public key cryptography called RSA algorithm and Elliptic Curve Digital Signature Algorithm (ECDSA). RSA algorithm and ECDSA are well known for a person with ordinary skill in information security field, and the detail thereof is omitted herein. In the present invention, only the receiver with the private key can implement the electronic device to see the encrypted information in the transaction, but the public key can be seen by everyone.

In step S303, when the first digital assets are released from one of the issuers to the one of the receivers, a plurality of first digital signatures for the transactions are respectively written with a private key of the one of the receivers in a plurality of blocks. The first digital signatures are generated in accordance with the current transactions information with the private key by the hash algorithm. The first digital signatures are used to verify and track whether the transactions are valid or not.

In step S304, a plurality of the first digital assets received in the one of the receivers are combined to be one of the second digital assets. After the receiver receives those first digital assets, it represents that the goods from the sellers are sold to the buyer. The buyer will produce new goods or a new product represented by the one of the second digital assets in accordance with the goods from the sellers, and then the buyer may become the seller. In other words, the receiver becomes the issuer. Therefore, the new one of the issuers is capable of selling the goods or product to another buyer.

For example, if the buyer would like to build a chair, the buyer needs some nails, woods and tools from some sellers. The nails, the woods and the tools are assigned with the first digital assets respectively. The sellers transport the nails, the woods and the tools to the buyer and the digital assets are transmitted to the receiver too. The buyer builds the chair by the woods, the nails and the tools, and the first digital assets are combined together to be the second digital asset.

In step S305, data relationships among the one of the second digital assets and the first digital assets are generated. In order to track the first digital assets and the one of the second digital assets in the future, the data relationships among the first digital assets and the one of the second digital assets are generated in advance. Therefore, the buyer, the seller or other people (such as the consumers, etc.) may track where the goods come from or go to, and the consumers may understand that the product is made of those goods and the goods are made from those sellers in accordance with the data relationship.

In step S306, the blocks are saved and encrypted with a plurality of the public keys in a blockchain. If any transactions occur during a period of time, the blocks representing the transactions with the first digital signatures will be saved and encrypted with the public keys by the hash algorithm. In order to secure and save all of the transactions occurring during the period of time, the blocks representing the transactions will be recorded and encrypted cyclically, such as every ten minutes.

Since the transactions may only happen in some of the sellers and some of the buyers, those sellers, buyers or other people (such as consumers) who do not participate in those transactions may want to understand those transactions. For example, those sellers, buyers or other people may want to know what the sellers sell or what raw materials are used to make the goods by the seller. Those sellers, buyers or other people may acquire some of the information of the transactions from the blockchain, but all of the detailed information within the transaction is only available for the buyers and sellers who are involved.

After the transactions between the issuers and the receiver are finished, the receiver may become a new one of the issuers. All of the aforementioned steps will be repeated again to perform other transactions.

In step S307, one of the receivers having one of the second digital assets becomes the new one of the issuers and the one of the second digital assets is transmitted to one of the receivers. For example, the chair made by one of the buyers will be sold to a consumer. The buyer becomes one of the issuers and the consumer is another one of the receivers. After the consumer purchases the chair, the second digital asset is transmitted to the receiver (the consumer).

In step S308, a second digital signature is written in one of the blocks according to the transaction for releasing the one of the second digital assets. For example, one of the receivers is a consumer. After the transaction of the second digital asset from the buyer (the issuer) to the consumer (the receiver) is completed, the second digital signature from the receiver as the consumer is written in accordance with the transaction and the private key. And also, the writing step is encrypted by the hash algorithm.

In step S309, the block in step S308 will be written in the blockchain. The blockchain in the present invention will check whether any one of the transactions occurring during one period of time, such as 5 minutes or 10 minutes. When the blockchain realizes that one of the transactions has occurred during the period of time, the block associated with the digital signature (such as the first digital signatures or the one of the second digital signature) will be written into the blockchain.

Moreover, the hash value of the distributed ledger is available on the internet for the sellers and the buyers. However, not every one of the electronic devices is capable of seeing all of the transactions within the distributed ledger. Only the electronic device with the private key may see the transactions performed by the electronic device.

At last, in step S310, a tracking symbol is developed in accordance with the blockchain. The tracking symbol in the present invention may be a barcode or a serial number and so on. The tracking symbol will be marked in one of the goods or products. When one user scans the bar code or inputs the serial number in the electronic device, the user is able to see the transaction history of the goods or products. If the user has the private key, the user is able to see the detail of the transaction of the goods or products.

For example, during the transactions for the digital assets, a farmer cultivates crops without spaying pesticides and releases a certification of the crops to a subcontracting plant via a mobile phone. SGS (Societe Generale de Suveillance) inspects raw materials made of the crops in a subcontracting plant and issues a compliance label. The subcontracting plant adds the certification from the farmer, the compliance label of the raw materials and a proof of automated production line packaging process together and releases a product certification for new goods.

At the shipping procedure, a kind of equipment automatic temperature detection for Internet of Things (IOT) is used and releases a compliance label to distributors. At last, the distributors label QR codes, bar codes or serial numbers related to the digital assets on the goods, and consumers can see all of the information of the digital assets of the goods through the website by scanning the bar/QR codes or inputting the serial numbers to trace the certification and the shipping information of the goods. Moreover, a blockchain explorer or API is used for the consumers to check or verify the content of the transactions.

Those farmers, the subcontracting planters or the distributors who are involved in the transactions own accounts (private keys) for the website. When one of the transactions is executed, those farmers, the subcontracting planters or the distributors can log in the website with their own accounts to upload or save the digital signatures (such as the first digital signatures or the second digital signatures) in the blockchain, which is linked to the website. The tracking symbols are similar to the public keys or some codes associated with the public keys. When the tracking symbol is inputted in the website, it is like the public key being entered into the blockchain and all of the transactions will be shown on the website.

It should be noted that the tracking symbol is public for everyone to check. Not only the buyers or sellers would be able to use the tracking symbol, but anyone may also access the tracking symbol and use the tracking symbol to see all of the transactions during the time of making the goods.

By the aforementioned steps, the goods and transactions from the sellers and the buyers can be tracked in the supply chain by implementing the technique of the blockchain. The sellers will know where their goods go to and the buyer will understand where those goods come from. And for security reason, a third party may understand there is a transaction happening between some of the issuers and some of the receivers, but the third party may not know the detail of the transaction, such as the cost of the goods and so on.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A supply chain recording method with traceable function by implementing blockchain technique, comprising steps of:
releasing a plurality of first digital assets respectively from a plurality of issuers having a plurality of private keys individually to one of a plurality of receivers as a plurality of transactions;
assigning a plurality of public keys respectively for the transactions;
writing a plurality of first digital signatures for the transactions respectively with one of the private keys from said one of the receivers in a plurality of blocks when the first digital assets are released from one of the issuers to said one of the receivers;
combining the first digital assets received in said one of the receivers to be one of a plurality of second digital assets;
generating data relationships among said one of the second digital assets and the first digital assets; and
respectively saving and encrypting the blocks with the public keys in a blockchain by a hash algorithm.

2. The supply chain recording method with traceable function as claimed in claim 1, wherein the public keys are derived from the private key.

3. The supply chain recording method with traceable function as claimed in claim 1, wherein the first digital assets and the second digital assets are encrypted by the hash algorithm.

4. The supply chain recording method with traceable function as claimed in claim 1, wherein the first digital signatures are encrypted by the hash algorithm.

5. The supply chain recording method with traceable function as claimed in claim 1, further comprising a step of reversing said one of the receivers having said one of the second digital assets to be a new one of the issuers.

6. The supply chain recording method with traceable function as claimed in claim 5, further comprising a step of releasing said one of the second digital assets from said new one of the issuers to a new one of the receivers.

7. The supply chain recording method with traceable function as claimed in claim 6, further comprising a step of writing a second digital signature in accordance with said one of the second digital assets released from said new one of the issuers to said new one of the receivers in one of the blocks in a distributed ledger.

8. The supply chain recording method with traceable function as claimed in claim 7, further comprising a step of writing said one of the blocks associated with the second digital signature in the blockchain.

9. The supply chain recording method with traceable function as claimed in claim 8, wherein the blockchain is saved in the issuers and the receivers.

10. The supply chain recording method with traceable function as claimed in claim 8, wherein the public keys are derived from the private key.

11. The supply chain recording method with traceable function as claimed in claim 8, wherein the first digital assets and the second digital assets are encrypted by the hash algorithm.

12. The supply chain recording method with traceable function as claimed in claim 8, wherein the first digital signatures are encrypted by the hash algorithm.

13. The supply chain recording method with traceable function as claimed in claim 8, further comprising a step of developing a tracking symbol in accordance with the blockchain.

14. The supply chain recording method with traceable function as claimed in claim 1, wherein the blockchain is saved in the issuers and the receivers.

15. The supply chain recording method with traceable function as claimed in claim 1, further comprising a step of developing a tracking symbol in accordance with the blockchain.
